(19) United States
(12) Patent Application Publication
(10) Pub. No.: US 2015/0304058 A1
(43) Pub. Date: Oct. 22, 2015

(54) System and method to provide the ability to the plurality of users to broadcast their plurality of personalized contents to their preferred device and preferred language

(71) Applicants: Johnson Manuel-Devadoss, Pearland, TX (US); Christy Aarthi Jones, Pearland, TX (US)

(72) Inventors: Johnson Manuel-Devadoss, Pearland, TX (US); Christy Aarthi Jones, Pearland, TX (US)

(21) Appl. No.: 14/588,916

(22) Filed: Jan. 3, 2015

Related U.S. Application Data
(60) Provisional application No. 61/923,636, filed on Jan. 3, 2014.

(51) Int. Cl. H04H 20/88; H04W 8/26; H04H 20/42; H04W 72/04; H04H 20/71

(52) U.S. Cl. CPC H04H 20/88; H04W 72/0453; H04H 20/71; H04H 20/42; H04W 8/26

(57) ABSTRACT

The present invention discloses a method and system to allow a plurality of users to broadcast their plurality of personalized contents to their plurality of preferred devices and listen to their plurality of personalized contents in their preferred plurality of natural language. The present invention creates user profiles and allows users to upload plurality of personalized content that is saved in data storage along with users natural language preferences. In another embodiment user can listen to their plurality of daily subscriptions from the plurality of third party content providers. Users can listen to the personalized content in preferred natural language by tuning radio frequency device to an allocated specific frequency channel. In another embodiment the user can connect any computing device to listen to the personalized content or use a touch-tone telephone to dial and listen to his personalized content in his preferred natural language.

### CROSS-REFERENCE TO RELATED APPLICATIONS

This application claims the benefit of U.S. Provisional Application No. 61/923,636, filed on Jan. 3, 2014, and incorporated by reference herein in its entirety.

### BACKGROUND

1. Field of the Invention

The present invention relates to broadcastings a plurality of personalized contents for plurality of users to their plurality of devices, more particularly allowing the plurality of users to listen to their plurality of personalized contents by tuning their radio frequency receiver device to their assigned frequency channel.

2. Description of Background Art

In this fast moving world, radio listeners spend most of their time traveling to places. While listening to the radio channel, they are forced to listen to the content that is broadcast by that specific radio channel. If user does not like the radio channels content, they may keep on changing the channels until they find the channel content that is interesting for them.

Internet radios are providing an ability to users to create their personalized playlist where they can choose their favorite songs or album and add them to their playlist. Whenever they are connected to the Internet they can play those songs from their created personalized content. If there were no Internet connection while traveling through remote areas they would not be able to listen to their personalized content.

Even if there is any existing system to provide an ability to user to listen to their personalized content none of the existing systems can provide the users to listen to their personalized content in their preferred natural language or different type of contents such as listening to latest news in his natural language or listening to their preferred language songs and listening to books in his natural language.

In order to listen to their preferred books or daily news paper subscriptions, first they need to find the hard copy of the books or daily news paper in his preferred language, convert it to the audio streams, burn into a CD or portable media disk where it can be played using a record playable device while traveling.

People can store personalized content on cloud storage but have to use specific devices to listen to the content stored in the cloud and need the device to be connected to the Internet. There is no system or method that enables a way to allow users to use his or her Radio Frequency device to listen to his or her personalized content without Internet connection. These types of devices are too expensive and configuring to specialized services is cumbersome.

The existing commercial Radio FM, Internet, and Satellite Radio channel are providing a pre-defined audio streams. This channel is common for all the listeners however the individual listener cannot use this service to broadcast their personalized content with their preferred language to their radio frequency device for their own purpose. Provisioning a plurality of Radio FM channel for the plurality of users is impossible task due to the Federal Communication Commission (FCC) regulations.

Hence there is no such system or method exists to provide the user to broadcast their personalized content to their radio frequency receiver device and to provide the ability to users to listen their personalized content in their preferred language.

### SUMMARY OF THE INVENTION

As mentioned above the current limitations of existing systems and methods, the present invention is disclosed to provide a plurality of users to broadcast their plurality of personalized contents to their plurality of preferred devices and listen to their plurality of personalized contents in their preferred plurality of natural languages.

In one embodiment, the present invention allows user to tune their radio frequency device to listen to their personalized content by providing the radio frequency device identification number using the subscriber device that is attached to the radio frequency device. The present invention creates user profile, allocates the storage space, allows the user to provide their third-party content provider subscriptions and upload any personalized content, allocates a specific frequency for each user and configures the allocated frequency to the subscriber device when user subscribes.

The user attaches the configured subscriber device with their RF receiver. The subscriber device triggers the principal of operation of present invention when user tunes their RF receiver to the allocated frequency channel. In some aspects of the subscriber device uses the telephony network to contact toll-free number to connect with base computing device if it could not communicate to the base computing device due to lack of internet connection.

In another embodiment, the present invention allows user to call toll-free number to provide their radio frequency device identification number and listen to their personalized content in their preferred language.

Still another embodiment of the present invention, the present invention provides a computer readable medium that may be installed into user's mobile device. The user may leverage the computer readable medium to upload and listen to their plurality of personalized contents and also provide the radio frequency device identification number to the base station system.

The present invention allocates the storage for the plurality of users where plurality of users stores their plurality of personalized contents. The present invention allocates a radio frequency device identification number to each individual user and uses that to identify their storage location.

In one aspect of user's personalized contents according to the present invention, provides the ability to user to upload their personalized contents that are in their natural language that can be broadcast over to the user's preferred device. In another aspect of user's personalized contents according to the present invention is to provide an ability to user to provide their third party content provider subscriptions. This way user can listen to their preferred personalized content from third party content provider through the present invention. The present invention communicates to the user's subscribed content provider to download the content and then translates it to the user's preferred language to broadcast it to the user's device.

Still there is another aspect of the present invention; it provides the ability to user to upload their textual content which can be converted to an audio stream before broadcasting it over to the user's preferred device. For example, a user would like to listen to textual contents of a book in his preferred language, he/she may scan the book and upload it to his allocated storage space and then the content may be converted to the audio stream and is being broadcasted to their preferred device. In another example, user may provide their existing daily news provider subscription, where present invention may directly connect to the daily news providers to retrieve the content from them, translate the content to user's preferred language(if necessary) and then broadcast it to their preferred device.

These together with other aspects of the present invention, along with the various features of novelty that characterize the present invention, are pointed out with particularity in the claims annexed hereto and form a part of the present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The accompanying drawings, which are incorporated in and constitute a part of this specification, illustrate an embodiment of the invention and, together with the description, explain the invention. In the drawings,

FIG. 1 is a diagram of an exemplary network in which systems and methods consistent with the principles of the invention may be implemented;

FIG. 2 is an exemplary diagram of base station computing device and user computing devices of FIG. 1 according to an implementation consistent with the principles of the invention;

FIG. 3A is the exemplary functional block diagram of base computing device of the present invention of FIG. 1 according to an implementation consistent with the principles of the invention;

FIG. 3B is the exemplary functional block diagram of subscriber device of the present invention of FIG. 1 according to an implementation consistent with the principles of the invention;

FIG. 3C is the exemplary functional block diagram of present invention Component 38 that resides in user computing device 12, 36 in accordance with an embodiment of the present invention;

FIG. 4A is a flowchart of exemplary operational sequences for broadcasting the user personalized content according to an implementation consistent with the principles of the present invention;

FIG. 4B is a flowchart of exemplary operational sequences of base station computing device 22 in accordance to the present invention;

FIG. 4C is a flowchart of exemplary operational sequences of subscriber device 26, 30 in accordance to the present invention;

FIG. 4D is a flowchart of exemplary operational sequences of computing device component 44 in accordance to the present invention;

FIG. 5A is an exemplary operation of the present invention of FIG. 1 according to an implementation consistent with the principles of the invention;

FIG. 5B is the exemplary operational sequences of one of the implementation of present invention of FIG. 1 according to an implementation consistent with the principles of the invention;

FIG. 5C is the exemplary operational sequences of another implementation of the present invention of FIG. 1 according to an implementation consistent with the principles of the invention; and

FIG. 6 is an exemplary user interface of notification email message from the present invention of FIG. 1 according to an implementation consistent with the principles of the invention.

### DETAILED DESCRIPTION OF THE INVENTION

The following detailed description of implementations consistent with the principles of the invention along with accompanying drawings indicated above. The same reference numbers in different drawings may identify the same or similar elements. In addition, the following detailed description does not limit the invention.

Implementation consistent with the principles of the invention is directed to broadcasting the plurality of users personalized content to the plurality of users radio frequency device. For example, implementations described herein may allocate the storage space for the user to upload their personalized content and converts the personalized content to the users their preferred language and broadcasts the personalized content of the individual user to their radio frequency device.

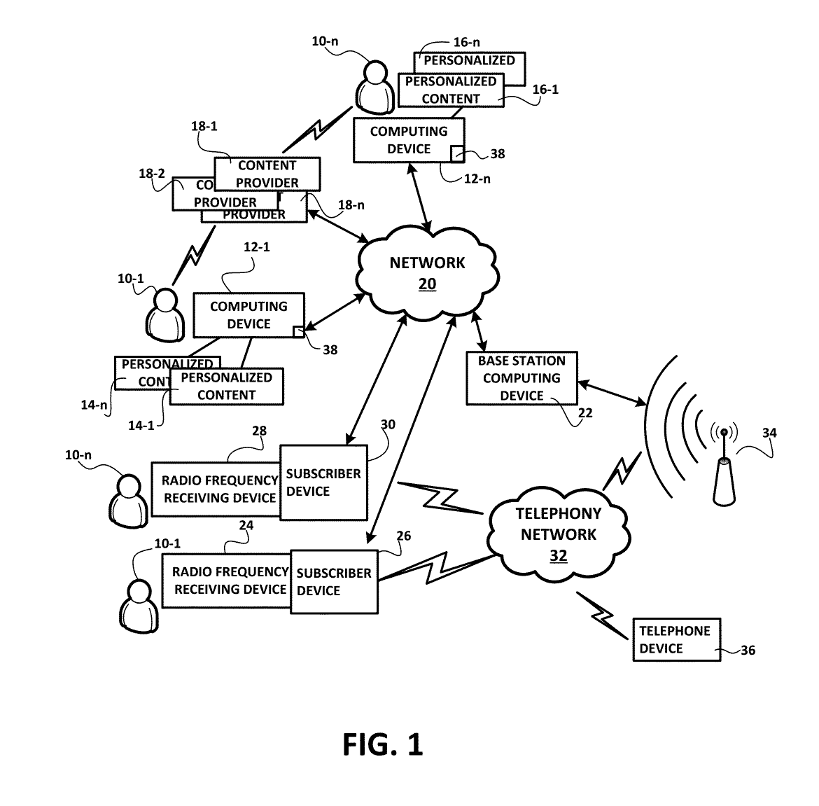

FIG. 1 is an exemplary diagram of a network 20 in which systems and methods consistent with the principles of the invention may be implemented. Network 20 may include multiple clients 12-1 . . . 12-N connected to base station computing device 22, personalized content providers 18-1, . . . 18-N (collectively referred to as “content provider ”) via a network 20. N clients 12, N content providers 18 and base station computing device 22 are illustrated as connected to network 20 for simplicity. In practice, there may be more or fewer clients and content providers. Also, in some instances, a client may perform a function of a content provider and a content provider may perform a function of a client.

Clients 12 may include client entities that can contact base station computing device through Component 38 for uploading the users personalized content in a manner consistent with the principles of the invention. An entity may be defined as a device, such as a personal computer, a wireless telephone, a personal digital assistant (PDA), a laptop, or another type of computation or communication device, a thread or process running on one of these devices, and/or an object executable by one of these devices.

Base station computing device 22 may include server entities providing the user interface to the users to upload their personalized content, contacting the content providers 18-1, . . . 18-N via network 20 to retrieve the plurality of users' subscribed plurality of contents, allocating the storage space for the plurality of the users, converting the plurality of users' personalized contents to their preferred language, broadcasting the plurality of users' personalized contents to their device. An entity may be defined as a device, such as a server, or another type of computation or communication device, a thread or process running on one of these devices, and/or an object executable by one of these devices. A user device may include a personal computer, a wireless telephone, a personal digital assistant (PDA), a laptop, or another type of computation or communication device, a radio frequency receiver device that include television sets, radar equipment, two-way radios, cell phones, wireless computer networks, GPS navigation devices, radio telescopes, Bluetooth enabled devices, a thread or process running on one of these devices, and/or an object executable by one of these devices.

The base station computing device 22 may facilitate interaction and communication among client computing devices 12-1 . . . 12-N and content providers 18-1 . . . 18-N via the network 20. In one embodiment, the base station computing device 22 may facilitate contacting the content providers 18-1 . . . 18-N of users 10-1 . . . 10-N to retrieve the subscribed content and converting it to their preferred language and then broadcasting it to their device.

Network 20 may include a local area network (LAN),an Internet Area Network, a wide area network (WAN), an Intranet, the Internet, a memory device, or a combination of networks. Clients 12, Base Station computing device 22, content providers 18, and base station 24 may connect to network 18 via wired, wireless, and/or optical connections.

Telephony network 32 is a wireless network distributed over land areas, each served by at least one fixed-location transceiver. Telephony network 32 may include the core circuit switched network, and the Public Switched Telephone Network (PSTN). The PSTN consists of telephone lines, fiber optic cables, microwave transmission links, cellular networks, communications satellites, and undersea telephone cables, all interconnected by switching centers, thus allowing any telephone in the world to communicate with any other.

Content providers 18 may include content publishing entities that publish the frequent update information of blog entries, daily news, and audio. Users 10 may subscribe with content providers 18 to receive the frequent update information of blog entries, daily news, and audio. Users 10 may provide the content provider 18 subscription information to base station computing device 22 to retrieve the frequent update information of their desire. An entity may be defined as a device, such as a server, or another type of computation or communication device, a thread or process running on one of these devices, and/or an object executable by one of these devices.

Personalized content 14 may include information entity that may provide value for an end-user/audience in specific contexts. An entity is the textual, visual or aural entity such as text, images, sounds, documents, data, books, newspaper, applications, e-services, images, audio, personal web pages, archived e-mail messages, and more.

Radio frequency receiving device 24, 28 may include an electronic device entity that receives radio waves and converts the information carried by them to a usable form. The radio frequency receiving device 24, 28 may consists of electronic filters to separate the desired radio frequency signal from all the other signals picked up by the antenna, an electronic amplifier to increase the power of the signal for further processing, and finally recovers the desired information through demodulation. An entity is a device that contains radio receivers includes television sets, radar equipment, two-way radios, cell phones, wireless computer, GPS navigation devices, and baby monitors. An entity is a device that may attach to the vehicles.

Subscriber device 26, 30 may include an electronic device entity that attaches to the radio frequency device 24, 28 via wired, wireless connection. The Subscriber device 26, 30 may use the network 20 or telephony network 32 and telephony network tower 34 to establish the connection to the base station computing device 22. The subscriber device 26, 30 uses the established telephony communication link when there is no internet connection. Radio Frequency Receiving Devices 24, 28 and Subscriber devices 26, 30 are illustrated for simplicity. In practice, there may be more or fewer Radio Frequency Receiving Devices and Subscriber devices. Also, in some instances, a Radio Frequency Receiving Device may perform a function of a Subscriber device and a Subscriber device may perform a function of a Radio Frequency Receiving Device.

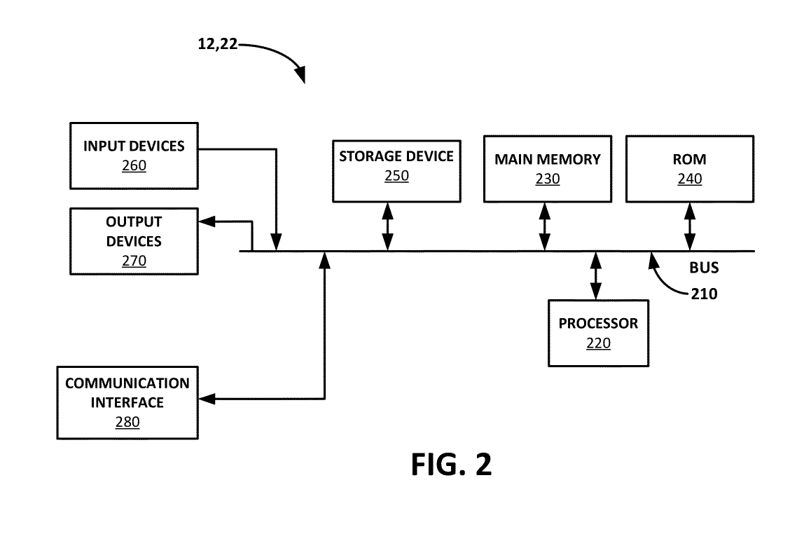

FIG. 2 is an exemplary diagram of a client or server entity (hereinafter called “client/server entity”), which may correspond to one or more of clients 12 and servers 22, according to an implementation consistent with the principles of the invention. The client/server entity may include a bus 210, a processor 220, a main memory 230, a read only memory (ROM) 240, a storage device 250, one or more input devices 260, one or more output devices 270, and a communication interface 280. Bus 210 may include one or more conductors that permit communication among the components of the Base Station Computing Device 22 entity.

Processor 220 may include one or more conventional processors or microprocessors that interpret and execute instructions. Main memory 230 may include a random access memory (RAM) or another type of dynamic storage device that stores information and instructions for execution by processor 220. ROM 240 may include a conventional ROM device or another type of static storage device that stores static information and instructions for use by processor 220. Storage device 250 may include a magnetic and/or optical recording medium and its corresponding drive.

Input device(s) 260 may include one or more conventional mechanisms that permit an operator to input information to the client/server entity, such as a keyboard, a mouse, a pen, voice recognition and/or biometric mechanisms, etc. Output device(s) 270 may include one or more conventional mechanisms that output information to the operator, including a display, a speaker, etc. Communication interface 280 may include any transceiver-like mechanism that enables the client/server entity to communicate with other devices and/or systems. For example, communication interface 280 may include mechanisms for communicating with another device or system via a network, such as network 20.

As it will be described in detail below, the base station computing device 22 entity, consistent with the principles of the invention, allocates a storage space to store their personalized content and broadcasting the user's personalized content to the users. The base station computing device 22 entity may perform these operations in response to processor 220 executing software instructions contained in a computer-readable medium, such as memory 230. A computer-readable medium may be defined as one or more physical or logical memory devices and/or carrier waves.

The software instructions may be read into memory 230 from another computer-readable medium, such as data storage device 250, or from another device via communication interface 280. The software instructions contained in memory 230 may cause processor 220 to perform processes that will be described later. Alternatively, hardwired circuitry may be used in place of or in combination with software instructions to implement processes consistent with the principles of the invention. Thus, implementations consistent with the principles of the invention are not limited to any specific combination of hardware circuitry and software.

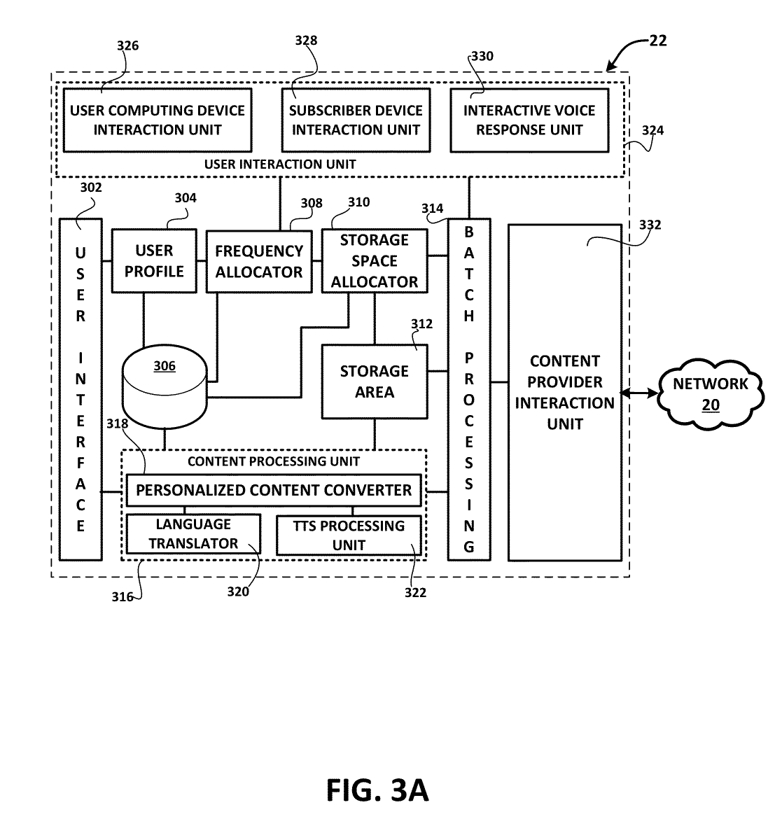

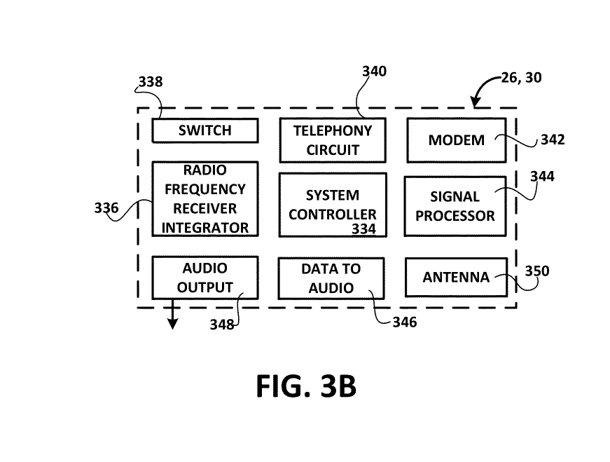

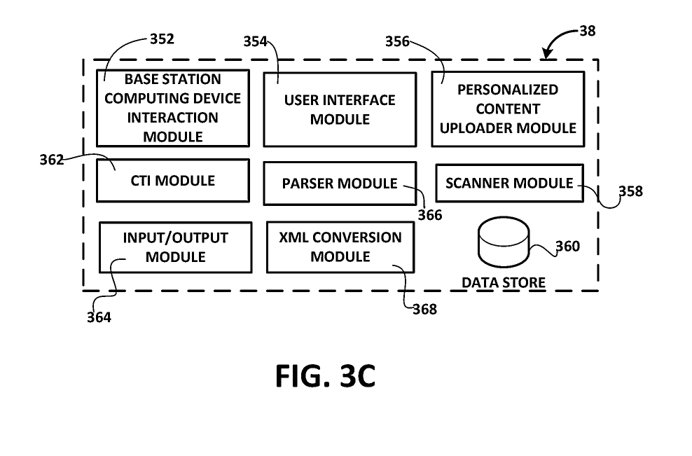

FIG. 3A illustrates the exemplary functional block diagram of the Base Station Computing Device 22 in accordance to the present invention. The functional block diagram of base station computing device 22 may include the User Interface 302, User Profile 304, User Profile Database 306, Frequency Allocator 308, Storage Space Allocator 310, Storage Area 312, Batch Processing 314, Content Provider Interaction Unit 332, Content Processing Unit 316, and User Interaction Unit 324. The Content Processing Unit 316 further comprises of Personalized Content Converter 318, Language Translator 320, and TTS Processing Unit 322. Similarly, the User Interaction Unit 324 comprises of User Computing Device Interaction Unit 326, Subscriber Device Interaction Unit 328, and Interactive Voice Response Unit 324.

User Interface 302 module is configured to help user to provide their preferences on the language, subscribed content provider information and upload their personalized content to their respective storage areas.

User Profile 304 module is provided for generating a user profile and assign a 9-digit hexadecimal radio frequency device identification number for user 10-1 . . , 10-n when user subscribes with present invention. When the user 10 adds additional information to the user profile, such as additional content providers, the user profile in the profile database may be updated with the information added. The user profile may be stored, modified, added, and so forth to any storage medium. A timestamp may be associated with the user profile.

User Profile Database 306 module is provided for storing data associated with each of the users, such as the user 10-1 . . . , 10-n associated with user device 12-1 . . . 12-n. When a user 10-1 . . . , 10-n subscribes to services provided by the present invention, a user profile may be generated for user 10-1 . . . , 10-n.

Frequency Allocator 308 module is responsible for generating a plurality of frequency channels for the plurality of users. The frequency allocator 308 may generate a frequency number between lower frequency (i.e., KHz) and higher frequency (i.e., GHz) spectrum. It assigns any number within that range regardless if any existing radio station is already allocated to a particular frequency channel. For example, Frequency allocator 308 module generates 87.9 KHz and assign it to a particular subscriber device. But some existing xyz FM station is already broadcasting their FM signals to same frequency channel 87.9 KHz. When user attaches the subscriber device of the present invention to their user radio frequency device, if they tune their radio frequency device to 87.9 KHz, the subscriber device may get triggered and bypasses the existing FM frequency channel. Instead of receiving the radio signals from xyz FM—87.9 KHz, present invention would establish the connection between user's radio frequency device to the base station computing device 22.

Storage Space Allocator 310 module is responsible for allocating the storage space for the plurality of users to store their personalized content. This module may allocate the storage space for the individual user to satisfy the shared storage requirement i.e., provide massive scalability and elasticity. The radio frequency device identification number may be used to uniquely identify the storage space allocated for each user.

Storage Area 312 module is closely connected with Storage space allocator and Batch processing module. It provides block-level storage that can be accessed by the applications running on any network servers. The storage area module is primarily used to provide user 10-1 . . . , 10-n with personalized content storage devices, such as disk arrays, tape libraries, accessible to base computing device 22 so that the storage appears like locally attached storage device to the operating system of base computing device 22.

Batch Processing 314 module is closely connected with user interaction unit 324, content processing unit 316, storage space allocator 310 and storage area 312. The Batch Processing 314 module plays an important role in the base station computing device such as generating the radio frequency device identification number, receiving the incoming request from either subscriber device or computing device or interactive voice response from end user, retrieving the plurality of personalized contents for the plurality of users based on the radio frequency device identification number, retrieving the subscribed contents from third party content providers, converting the plurality of personalized contents to the plurality of users preferred language, converting them to audio signals and propagating the plurality of audio streams to the corresponding devices such as subscriber device, or user computing device or telephony device.

Content Provider Interaction Unit 332 is responsible for establishing the communication between a plurality of content providers 18 for the plurality of users' subscriptions and base station computing device through the network 20. Batch processing 320 module may provide the plurality of users' subscriptions information to the Content Provider interaction unit 332 to the establish the communication to the respective plurality of content providers and retrieve the subscribed personalized contents whenever the new updates are available for the plurality of users subscribed plurality of contents.

Content Processing Unit 316 is responsible for converting the plurality of users personalized contents to their preferred language and audio streams. The three major components such as Personalized Content Convertor 318, Language translator 320, and TTS (Text-To-Speech) Processing Unit 322 are involved in processing the plurality of users personalized contents.

Personalized Content Convertor 318 module is configured to provide the audio stream for the user 10-1 . . . , 10-n personalized content in their preferred language. The personalized content may consist of subscribed information such as RSS Feeds, blogs, articles, daily news, magazines, songs, podcasts and other audio streams from one or more content providers. It is closely coupled with language translator 320 and TTS processing unit 322 modules.

Language Translator 320 module is configured to convert the user 10-1 . . . , 10-n personalized content to their specified language. Language translator 320 module may use the natural language processing technology to convert source-language text or sounds to an equivalent target-language text or sounds.

TTS Processing Unit 322 module is responsible for converting the translated text to audio streams. It may use a Text-To-Speech (TTS) technology to convert the text content to audio streams. The plurality of users personalized contents may comprise of textual content. These personalized contents are being processed using TTS Processing Unit 322.

The User Interaction Unit 324 is responsible for sending and receiving the requests from and to a plurality of users or devices. The main functionality of User Interaction Unit 324 is providing a technology that allows a user computing device or subscriber device or touch tone telephone to interact with base station computing device through either the use of voice and DTMF (Dual-tone multi-frequency) inputs or the use of internet.

User Computing Device Interaction Unit 326 establishes a communication path between user computing device via a computer readable medium (i.e., Component 38) of present invention that is installed on the user computing device and network 20. When request comes from plurality of users computing devices through Component 38 and the network 20, it parses the request to determine the radio frequency device identification number and passes it to the batch processing unit.

Subscriber Device Interaction Unit 328 acknowledges the incoming request and parses the subscriber request to determine radio frequency device identification number from the incoming request.

Interactive Voice Response Unit 324 may receive an input request from either user computing device or subscriber device or DTMF tones from user touch-tone telephone. The Interactive Voice Response Unit 324 is responsible for obtaining the radio frequency device identification number from the incoming request and passes it to the batch processing unit 314.

FIG. 3B illustrates the exemplary functional block diagram of the Subscriber Device 26, 30 in accordance to the present invention. The exemplary functional block diagram of Subscriber device 26, 30 may include the system controller 334, radio frequency receiver integrator 336, switch 338, telephony circuit 340, modem 342, signal processor 344, antenna 350, data to audio 346, and audio output 348.

When frequency allocator of base station computing device generates the frequency channel for a specific user, that frequency channel is being set into the system controller 334 of subscriber device which means system controller is being pre-tuned to a frequency that is allocated to the user along with radio frequency device identification number. System Controller 334 gets activated when user tunes their radio frequency receiving device to the allocated frequency, which matches with the frequency configured with system controller 334. System Controller 334 tries to contact base station computing device via modem 342. System Controller leverages a telephony circuit 340 to establish the communication path between base station computing device and subscriber device when it could not establish the connection to the base station computing device via modem 342.

Radio Frequency Receiver Integrator 336 is closely connected to user's radio frequency receiver and subscriber device. It plays an important role in bypassing the radio frequency channel when user tunes their radio frequency receiver to the allocated frequency channel. In some aspect, the data may feed into radio frequency receiver from subscriber device through the radio frequency receiver integrator 336.

Telephony Circuit 340 is being used when system controller 334 could not reach to the base station computing device through modem 342. Telephony circuit 340 is preconfigured to invoke a DTMF request to the base station computing device 22 Interactive Voice Response Unit. Once it is being connected to the base station computing device, then system controller 334 sends the assigned radio frequency device identification number to interactive voice response unit via DTMF.

Signal Processor 344 is used in the processing or transferring of received information from base station computing device that may contained in a different form of signals and uses mathematical, statistical, computational, heuristic, and linguistic representations, formalisms, and techniques for representation. Data to audio 346 converts the received signals from base station computing device to the useful form of signal which can be fed into either user radio frequency receiver or user radio frequency receiver audio output device. Audio Output 348 is being used to amplify the signals before it is being sent to the user radio frequency device audio output.

FIG. 3C provides a more detailed illustration of present invention Component 38 that resides in user computing device 12, 36 in accordance with an embodiment of the present invention. The present invention component may include a Base Station Computing Device Interaction Module 352, User Interface Module 354, Personalized Content Uploader Module 356, Scanner Module 358, Data Store 360, CTI (Computer Telephony Integration) Module 362, Input/output Module 364, Parser Module 366 and XML Conversion Module 368. The illustrated components work together to perform the functions of present invention Component 38 residing in user computing device 12, 36 described below.

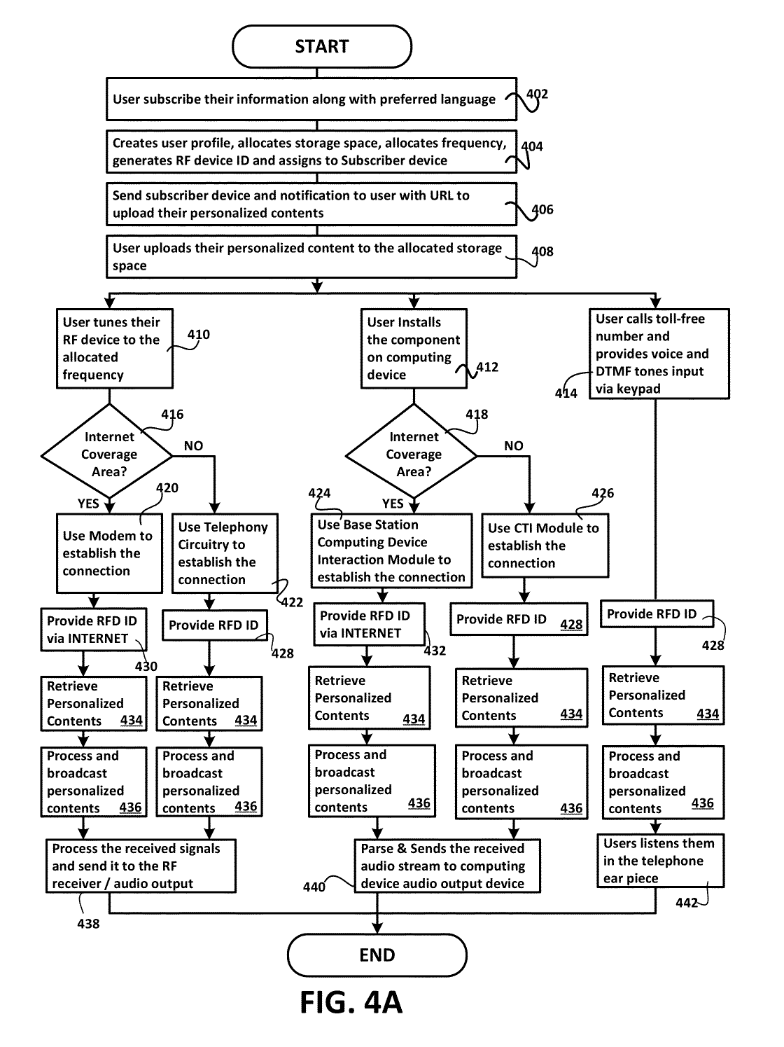

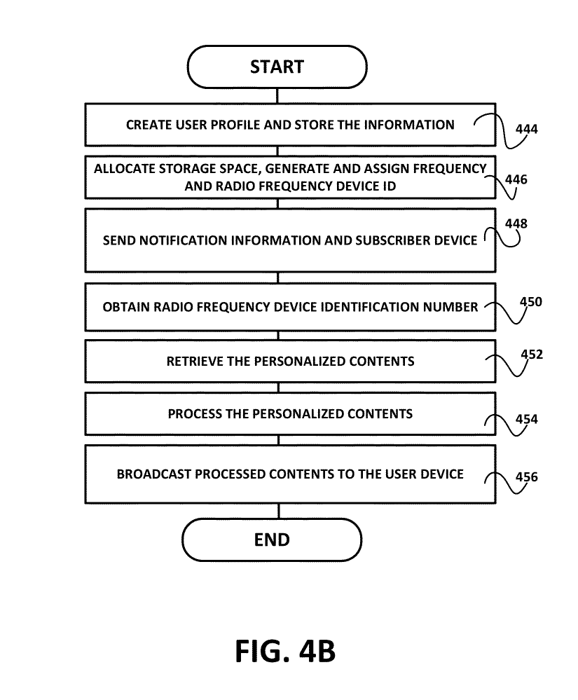

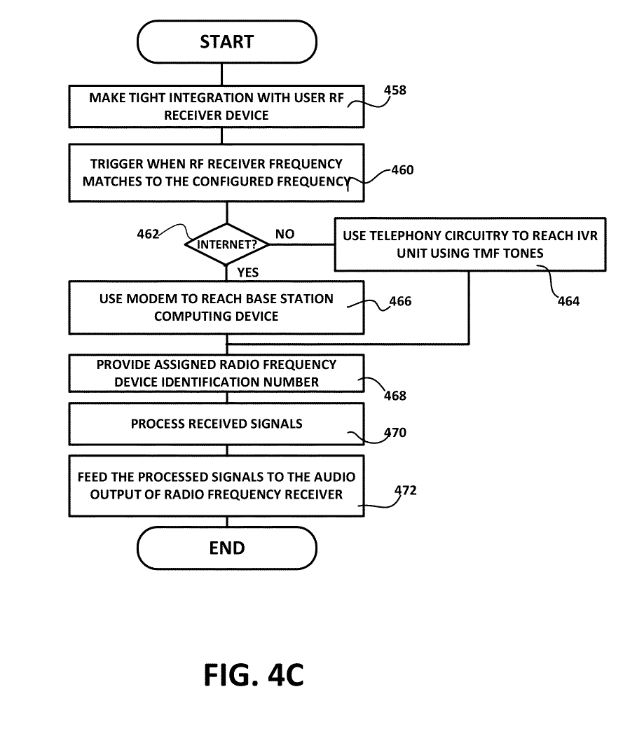

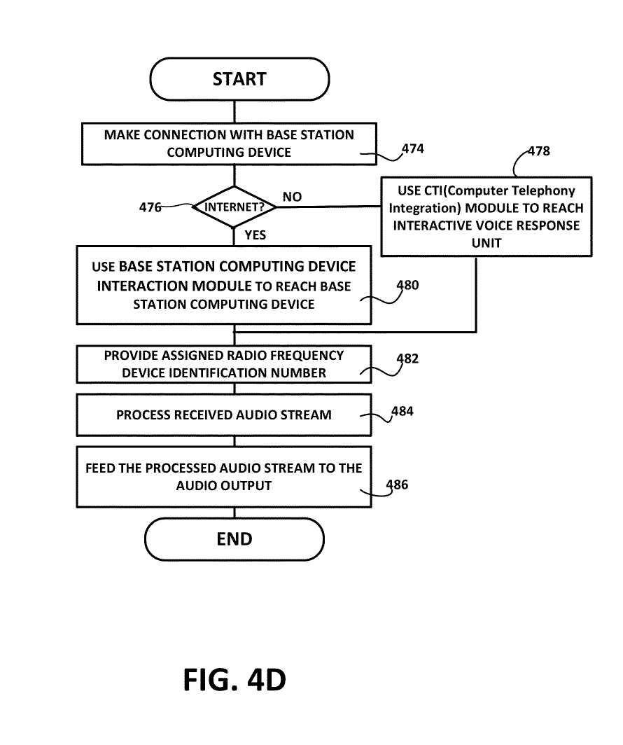

FIG. 4A is a flowchart of exemplary operational action sequences for broadcasting the users personalized content according to an implementation consistent with the principles of the present invention. In Act 402, user subscribes with the present invention where user provides their information such as a name, an address, an email address, a phone number, a plurality of vehicles identification number, an interest on books, a favorite music, the movies, a preferred third party content providers to listen their daily updates such as Newspaper, blogs, feeds, and preferred language to listen their personalized contents.

In Act 404, the present invention creates the user profile based on the provided information and stores them into the user profile database 306. Then it generates a specific frequency number from 3 kHz to 300 GHz and a 9-digit hexadecimal radio frequency device identification number and assigns them into the new subscriber device for the registered user. Once a new frequency is generated, a confirmation notification may be prompted to the user to indicate that when he tunes his radio frequency receiver to the allocated frequency, if there any existing FM channel is associated with the assigned frequency number then it will be nullified. If user does not agree and would like to reassign a different frequency number then it would re-generate a new frequency from 3 kHz to 300 GHz. Example, a ABC FM Channel is registered with 99.2 MHz and user is listening to the audio streams from ABC FM channel by tuning his radio frequency receiver to 99.2 MHz.

The present invention may allocate a same frequency channel i.e., 99.2 MHz and when user tunes his radio frequency receiver with subscriber device attached then he would not listen to ABC FM channel programs instead he may listens to his personalized contents via subscriber device. If user prefers to listen ABC FM channel in 99.2 MHz then the present invention would re-generate a new frequency number based on the user's request and then assign/pre-tune the generated the frequency to the system controller of subscriber device.

In Act 406, the present invention sends the email notification to user with instructions on how to use this service along with generated frequency number, and radio frequency device identification number. User uploads their personalized contents to the present invention using a computer readable medium component 38 installed on their computing devices as mentioned in Act 408. While uploading the contents from user computing device, the component 38 leverages the scanner module to scan the documents to make sure there will be no infected contents prior to storing them into the allocated storage space.

In Act 410, the principle of one of the embodiment of present invention operation begins when user tunes their radio frequency receiver to the allocated frequency, which triggers the switch that is closely connected to subscriber device. Example, user may plug-in the subscriber device to their car computing system or audio system to connect to the radio. Typically, the system controller of the subscriber device may have a pre-tune or assigned to the allocated frequency for the user. When user tunes to the allocated frequency which matches the frequency in the system controller, the switch will be triggered to begin contact with the base station computing device.

As mentioned in Act 416, the subscriber device tries to establish the communication path to the base station computing device via network. When subscriber device could not reach to the base station computing device due to no internet connection available, then system controller triggers the telephony circuitry to call the toll-free number to establish communication to the base station computing device via Interactive Voice Response Unit as mentioned in the act 420 and 422. If system controller connects to the base station computing device using telephony circuitry then rest of the transactions between base station computing device and subscriber device will take place using telephonic signals until system controller can establish the connection with base station computing device using Modem and network. If system controller establishes the communication path to the base station computing device using Modem then it passes the radio frequency device identification number via network as mentioned 430.

In Act 424, if Internet connection is available the computer readable medium component 38 uses the Base station computing device interaction module to contact the user computing device interaction unit of base station computing device. Once the connection is established then component 38 sends the user's radio frequency device identification number to retrieve the personalized contents from the storage space and subscribed third party content providers. In Act 426, if Internet connection is unavailable component 38 may leverage the Computer Telephony Integration (CTI) module to establish the connection with base station computing device through telephony network.

In Act 434, the base station computing device, uses the received radio frequency device identification number and looks for the personalized contents from allocated storage space and also contacts the users subscribed third party content provider. In one aspect of present invention, user may have subscribed with a plurality of third party content providers. The base station computing device contacts the plurality of user subscribed content providers and retrieves the daily updates from them.

In Act 436, the retrieved personalized contents are being processed according to the user's preferred language. The base station computing device extracts the personalized contents and converts to users preferred language. The base station computing device uses Text-to-speech technology to convert personalized textual content to users preferred language and then to the form of audio signals, which can be listened by the user's radio frequency receiver's audio device through subscriber device. The converted audio signal is sent to the requested subscriber device.

In Act 438, subscriber device receives the signals and processes it to a form of input, which can be fed into the user's radio frequency receiver's audio device. In another embodiment of present invention operation begins when user downloads and installs the computer readable medium component 38 into their computing device as mentioned in 412. Once installed user clicks on the computer readable medium component 38, which prompts the user to provide the radio frequency device identification number. In Act 418, the computer readable medium component 38 tries to establish connection with base station computing device.

In Act 440, the received audio signals from base station computing device are being processed by parsing them the received streams and decoding them to a raw stream and encoding them with format that is suitable for the user computing device. Example, if user has downloaded the component 38 of present invention to their windows operating system computing device then Parsing module would decode the received streams and encode with format that suitable for windows operating system. In some aspect, the received signals from interactive voice response unit to the CTI module may contain XML schemes. The computer readable medium component 38 of present invention parses them by using XML conversion module to extract the raw data and encode it with the format that is suitable for the user computing device.

As mentioned in the Acts 414, 428, 434, 436, 442, is another embodiment of present invention where user may use their telephony device to call base station computing device using provided toll-free number. When user calls toll-free number of base station computing device, it may reach to Interactive Voice Response Unit which may request the user to enter their radio frequency device identification number. User may enter their radio frequency device identification number using touch tone keypad. The Interactive Voice Response Unit may receive the user input and pass them it to batch processing unit. The batch processing unit retrieves the user's personalized contents from allocated storage space and their subscribed content provider (if any). The retrieved contents are being processed to the user's preferred language and converted to the audio signals and broadcast back where user may listen to it using ear piece of his phone.

FIG. 4B is a flowchart of exemplary operational action sequences for base station computing device according to an implementation consistent with the principles of the present invention. In Act 444, the base station computing device creates the user profile for the given user information and stores them in to the database. When it creates a user profile, it generates a 9-digit radio frequency device identification number for the registered user. The user profile 304 module generates a 9-digit radio frequency device identification number using date of birth of registered user and allocated subscriber device serial number. The base station computing device validates the user provided third party content provider subscription by communicating with the third party content provider on behalf of user using provided user credentials and checks the subscribed contents, frequency of scheduled updates on each of the subscribed contents, etc.

In Act 446, the base station computing device allocates a storage space, frequency number for the registered user and configures the subscriber device with assigned frequency and radio frequency device identification number. The storage allocator module allocates a subset of a larger storage volume to an each individual user and it may be referred with assigned radio frequency device identification number. The storage volume could be an entire single disk drive, a partition (subset) of a single disk drive, or disk volume from a RAID controller comprising multiple disk drives aggregated together for larger capacity and redundancy. Once storage space is allocated then it may choose a frequency number between low frequency and high frequency. The chosen frequency is tuned with system controller, which may contain a RF circuitry. The frequency number and radio frequency device identification number are being stored into system controller memory using EEPROM program while configuring the subscriber device for the registered user.

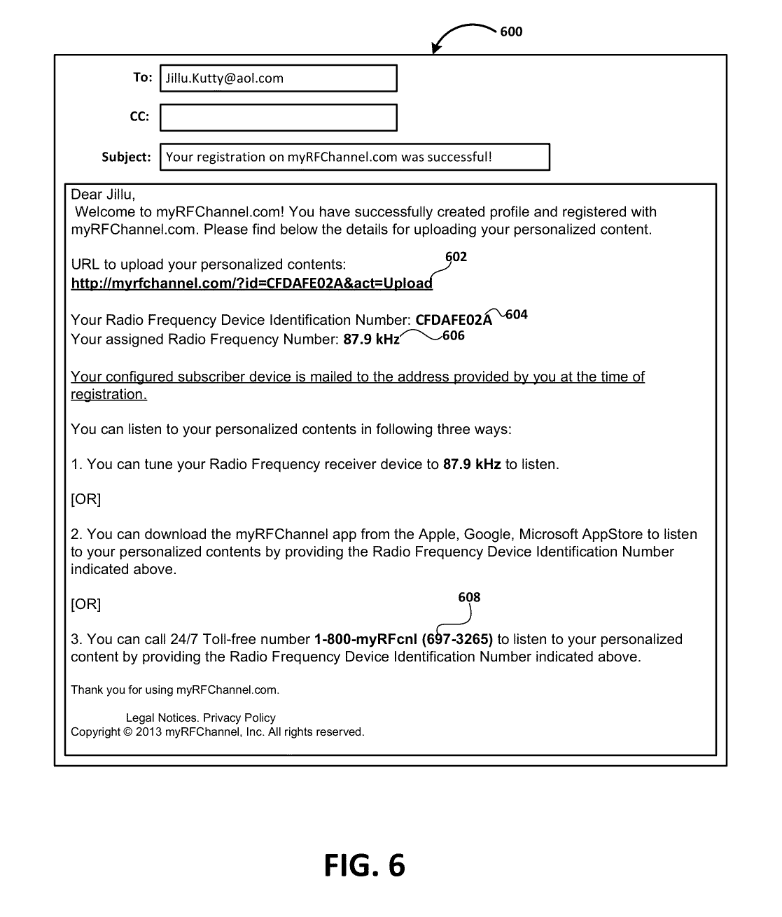

In Act 448, base computing device sends an email notification through user computing device interaction unit with allocated frequency and radio frequency device identification number as shown in the FIG. 6. Also, it sends the configured subscriber device to user through the postal.

In Act 450, the batch processing unit of base station computing device determines the radio frequency device identification number from received request using user computing device interaction unit, subscriber device interaction and interactive voice response unit. In one embodiment, the subscriber device sends the radio frequency device identification number from its memory along with request to the base station computing device. The subscriber device interaction unit of the base station computing device extracts the radio frequency device identification number from the incoming request and passes it to the batch processing unit. Similarly, in other embodiment, the base station computing device of the present invention may determine the radio frequency device identification number from the user computing device interaction unit that receives request from the computing medium readable component 38 of the user computing device. Yet another aspect of determining the radio frequency device identification number is from incoming telephonic call or DTMF tones. The user computing readable medium component 38 or subscriber device or user may using the telephone device may provide the radio frequency device identification number through DTMF tones.

In Act 452, the batch processing unit of the base station computing device may receive the radio frequency device identification number. In one aspect on retrieving the personalized contents for the user, the batch processing unit queries against database 306 to retrieve the user's subscribed third party content provider. Once the third party content providers are determined then batch processing unit leverages the content provider interaction unit to establish the connection to the obtained content providers and retrieves the subscription content. In another aspect on retrieving the personalized contents for the user, the batch processing unit determines the allocated subset of storage space from storage area using provided radio frequency device identification number and retrieves the user's personalized contents uploaded by the user.

In Act 454, the retrieved personalized contents for the user are being sent to the content processing unit. Content Processing Unit leverages the language translator module to convert the retrieved personalized contents and then it is being sent to the TTS Processing unit to translate any textual content to the audio content. The raw audio content is being encoded with specific format, which is suitable to send across to the subscriber device or user computing device or telephone device. The processed contents are being sent to either subscriber device or user computing device component 38 or user telephone depending on where the request is received from as shown in Act 456.

FIG. 4C is a flowchart of exemplary operational action sequences for subscriber device according to an implementation consistent with the principles of the present invention. In Act 458, the subscriber device leverages the radio frequency receiver integrator 336 to connect with radio frequency receiver device. In one aspect, the radio frequency receiver integrator may provide a standard 16-pin connector to connect with frequency receiver device and it may use the controller area network protocols or all other protocols. Example., it may uses the OBD-II protocols when it is being connected with vehicle radio frequency receiver device. The subscriber device may attach to the vehicle audio system using 16-pin connector to provide a tighter connection to the vehicle audio output.

In Act 460, once subscriber device establishes the connection with user radio frequency receiver, it gets triggered when user tunes his radio receiver device to the allocated frequency and it matches to assigned frequency in the subscriber device's System controller 334. As shown in the Act 462, 464, and 466, the subscriber device tries to establish the communication path to the base station computing device via network. When subscriber device could not reach to the base station computing device due to no internet connection availability, then System controller triggers the Telephony circuitry 340 to call the toll-free number to establish communication to the Interactive Voice Response Unit of the base station computing device. If system controller connects to the base station computing device using Telephony circuitry then rest of the transactions between base station computing device and subscriber device will take place using telephonic signals until system controller can establish the connection with base station computing device using Modem 342 and network.

In Act 466 the system controller establishes the communication path to the base station computing device using Modem. In Act 468, after connection with the base station computing device is made the subscriber device passes the radio frequency device identification number via network. In Act 470, 472 subscriber device receives the signals and processes to the form of input which can be fed into the user's radio frequency receiver's audio device.

FIG. 4D is a flowchart of exemplary operational action sequences for a computer readable medium component 38 according to an implementation consistent with the principles of the present invention. In Act 474, user downloads the computer readable medium component 38 from the mobile apps store or from the base station computing device user interface. If user computing device is connected with network then it uses the base station computing device interaction module to establish the connection as shown in Act 476 and 480.

In Act 478, if user computing device could not connect with network then it uses the computer telephony integration module to make a call to the interactive voice response unit of base station computing device to provide the radio frequency device identification number. This connection allows data collected from the user computing device to be used as input data to provide radio frequency device identification number and receive the audio streams of their personalized contents.

In Act 484, the received audio input stream from the base station computing device is being decoded to a raw stream and encoded with format that is suitable for the user computing device. In one aspect, XML conversion module extracts the scheme from the received input to determine the characteristics of it. These audio stream objects are analyzed to determine characteristics such as encoding format, playout duration, bitrate, resolution and codec. Similarly, the user computing device's supported audio format may identify the encoding standards. The received audio stream objects are being encoded with identified user computing device's supported format and sent through user computing device audio output as mentioned in the Act 486.

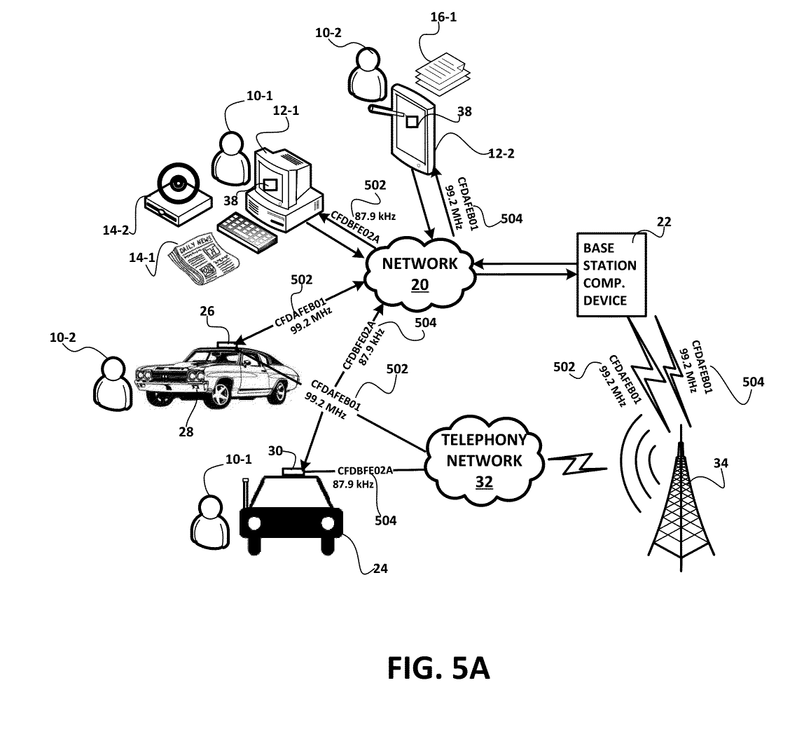

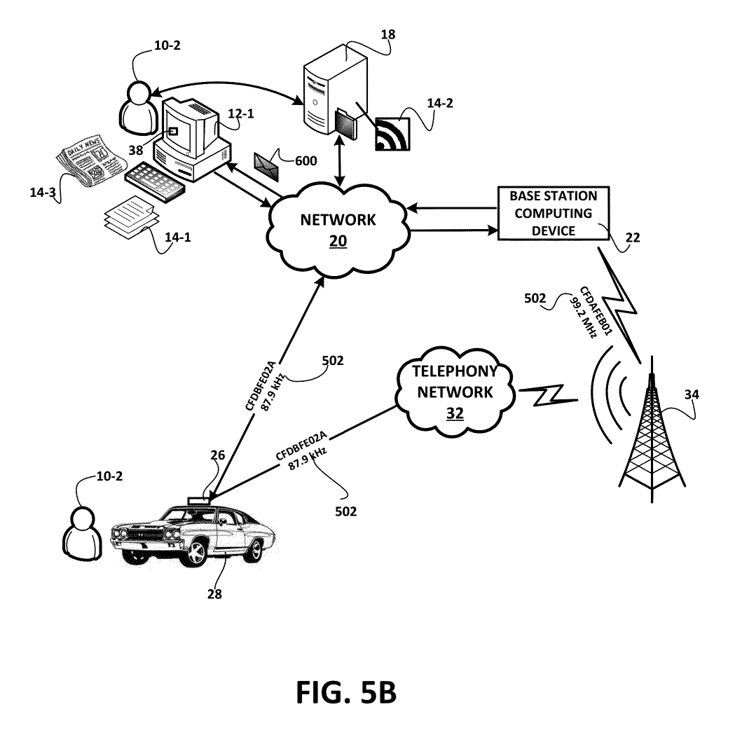

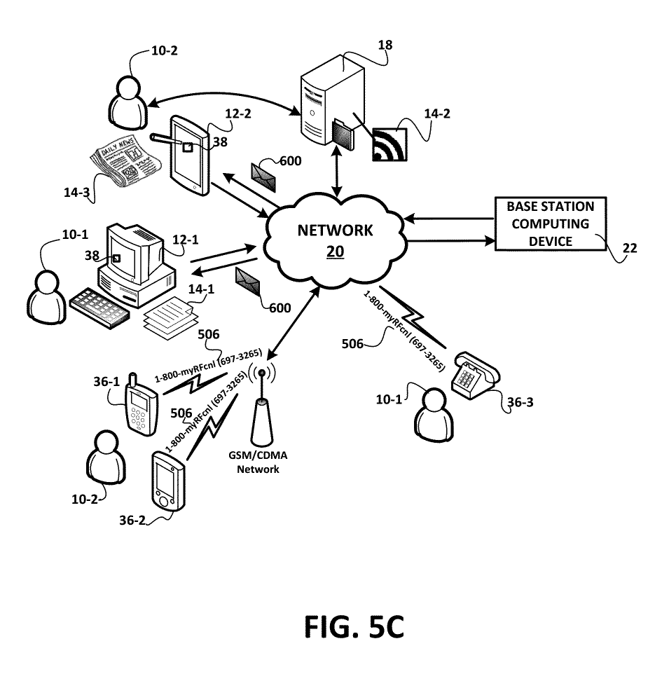

FIG. 5A shows an example of the operation of the present invention in accordance to FIG. 1. Two users 10-1 and 10-2 register their information with present invention either using Base Station Computing Device's User Interface Module or the computer readable medium Component 38 of present invention that may be installed on their computing devices 12-1 and 12-2. The base station computing device 22 registers 10-1 and 10-2 users' information and generates the radio frequency device identification numbers CFDBFE02A and CFDAFEB01 respectively. Also, it allocates the frequency numbers 87.9 kHz and 99.2 MHz for the users 10-1 and 10-2 respectively. The base station computing device 22 configures the subscriber devices 30, 26 with assigned frequencies (i.e., 87.9 kHz and 99.2 MHz) and radio frequency device identification numbers (i.e., CFDBFE02A and CFDAFEB01) and sends the notification to the users 10-1 and 10-2 through network 20 with assigned radio frequency device identification numbers (i.e., CFDBFE02A and CFDAFEB01) and allocated frequency numbers (i.e., 87.9 kHz and 99.2 MHz).

User 10-1 uploads his personalized contents such as daily newspaper 14-1 and audio stream 14-2. User 10-1 may scan the daily newspaper 14-1 to upload the scanned copy of it to the base station computing device using component 38 from his computing device 12-1. Similarly, User 10-2 scans his personalized content such as paper material 16-1 and uploads it through component installed on his computing device 12-2.

The user 10-1 attaches his subscriber device 30 with his vehicle 24 radio frequency receiver device. The user 10-1 tunes the radio frequency receiver device of vehicle 24 to assigned frequency i.e., 87.9 kHz. The subscriber device 30 gets triggered when user 10-1 tunes to 87.9 kHz and communicates to base station computing device 22 to provide his 10-1 radio frequency device identification number 504. The base station receives the radio device frequency identification number 504 from subscriber device 30 and retrieves the personalized contents 14-1, 14-2 and processes them by converting to the users preferred language and sends it back to the subscriber device 30. The subscriber device 30 parses them and feeds them into the vehicle 24 audio device.

In some aspect, subscriber device 30 could not communicate to the base station computing device 22 via network 20 due to user's 10-1 vehicle 24 may travelled to someplace where it could not connect to the network 20. During this situation, subscriber device 30 may communicates to the base station computing device using telephony network 32.

Similarly, the user 10-2 attaches his subscriber device 26 in his vehicle 28 radio frequency receiver device. The user 10-2 tunes the radio frequency receiver device of vehicle 28 to assigned frequency i.e., 99.2 MHz. The subscriber device 26 gets triggered when user 10-2 tunes to 99.2 MHz and communicates to base station computing device 22 to provide his 10-2 radio frequency device identification number 502. The base station receives the radio device frequency identification number 504 from subscriber device 26 and retrieves the personalized contents 16-1 and processes them by converting to the users preferred language and sends it back to the subscriber device 26. The subscriber device 26 parses them and feeds them into the vehicle 28 audio device.

The FIG. 5B shows another example of present invention functionality, which broadcasts a user's 10-2 personalized content 14-2 updates from his subscribed content provider 18 to his vehicle 28 radio frequency receiver device. A user 10-2 provides his subscription on content provider 18 to the base station computing device 22 during the registration process. While retrieving content for the provided radio frequency device identification number, the base station computing device contacts the content provider 18 to retrieve the updates on user's 10-2 subscribed personalized content 14-2. Example, user 10-2 subscribed with technical blogs 14-2 from wordpress.com 18. The base station computing device 22 contacts wordpress.com 18 to retrieves the RSS Feeds 14-2 on technical blogs for the user 10-2, processes them by converting to the users preferred language and broadcast them to the user's 10-2 vehicle's 28 subscriber device 26 which then parses and feeds them into the vehicle 28 audio device.

The FIG. 5C shows as another example of present invention functionality as users 10-1 and 10-2 make a call to the provided toll-free number 506 from their telephony devices 36-3, 36-2, and 36-1 to connect to the base station computing device 22. Users 10-1 and 10-2 may provide the radio frequency device identification number to the base station computing device using telephony devices 36-3, 36-2, and 36-1 keypad.

FIG. 6 illustrates the exemplary notification message from base station computing device 22 to the user. The base station computing device 22 sends the notification message 600 to the plurality of users when they subscribe with the present invention. The notification message 600 may include the URL 602 to upload his/her personalized contents, the 9-digit radio frequency device identification number 604, the assigned frequency number 606 to tunes his radio frequency receiver, and toll-free telephone number 608 to listen to the personalized contents.

The present invention has been described in particular detail with respect to a limited number of embodiments. Those of skill in the art will appreciate that the invention may additionally be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component. For example, the particular functions of the base station computing device 22, Subscriber device 26, 30 and present invention component 38 residing in user computing device 12, 36 may be provided in many or one module.

Some portions of the above description present the feature of the present invention in terms of algorithms and symbolic representations of operations on information. These algorithmic descriptions and representations are the means used by those skilled in the art to most effectively convey the substance of their work to others skilled in the art. These operations, while described functionally or logically, are understood to be implemented by computer programs. Furthermore, it has also proven convenient at times, to refer to these arrangements of operations as modules or code devices, without loss of generality.

It should be borne in mind, however, that all of these and similar terms are to be associated with the appropriate physical quantities and are merely convenient labels applied to these quantities. Unless specifically stated otherwise as apparent from the present discussion, it is appreciated that throughout the description, discussions utilizing terms such as “processing” or “allowing” or “configuring” or “generating” or “obtaining” or “determining” or “retrieving” or “providing” or “establishing” or “converting” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems. The present invention also relates to an apparatus for performing the operations herein. This apparatus may be specially constructed for the required purposes, or it may comprise a general-purpose computer selectively activated or reconfigured by a computer program stored in the computer. Such a computer program component may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description above. In addition, the present invention is not described with reference to any particular programming language. It is appreciated that a variety of programming languages may be used to implement the teachings of the present invention as described herein, and any references to specific languages are provided for disclosure of enablement and best mode of the present invention.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

What is claimed is:

1. A system comprising:
one or more processors; and
a computer-readable medium embodying instructions that, when executed by the one or more processors, cause the one or more processors to allow a plurality of users to listen their plurality of personalized contents to their plurality of devices in their preferred language, the instructions comprising instructions for:
generating a 9-digit hexadecimal Radio Frequency Device Identification Number for the individual users;
allocating an individual storage space for the plurality of users by uniquely identifying them using the generated 9-digit hexadecimal radio frequency device identification number;
allocating an individual frequency channel number to the individual user to tune their radio frequency receiver device to listen to their plurality of personalized contents;
configuring the plurality of subscriber devices for the plurality of users with allocated frequency channel number and generated 9-digit radio frequency device identification number;
allowing a plurality of users to upload their plurality of personalized contents to their respective allocated storage space and to provide their plurality of subscribed contents to be retrieved from the plurality of third party content providers;
retrieving at least one of the personalized contents for the plurality of users from their respective allocated storage space by using received 9-digit hexadecimal Radio Frequency Device Identification Number from at least one of the user device;
retrieving at least one of the personalized contents for the plurality of users from the plurality of subscribed third party content providers;
processing at least one of the personalized contents of the plurality of users;
allowing a plurality of users to listen to their plurality of personalized contents by tuning their radio frequency receiver device to the allocated frequency channel;
allowing a plurality of users to listen to their plurality of personalized contents through Interactive Voice Response Unit by providing their allocated 9-digit hexadecimal radio frequency device identification number via DTMF tones.

2. The system of claim 1, the provided preconfigured subscriber device with generated 9-digit hexadecimal Radio Frequency Device Identification Number and allocated frequency number is attached to radio frequency receiver device.

3. The system of claim 1, wherein said tuning their radio frequency receiver device to the allocated frequency channel is to initiate the subscriber device to establish the communication to the base station computing device by providing the 9-digit assigned radio frequency device identification number to retrieve and process their plurality personalized contents.

4. The system of claim 1, a frequency channel number is chosen between 3 kHz to 300 GHz that is to be configured with subscriber device.

5. The system of claim 1, a 9-digit hexadecimal radio frequency device identification number generated by using date of birth of registered user and allocated subscriber device serial number.

6. The system of claim 1, wherein said processing the retrieved plurality of personalized contents is converting at least one of the personalized contents to users preferred language and then converting it to the useful form of input that can be fed into the plurality of users device audio output.

7. The system of claim 1, wherein said personalized content comprises at least one of:
content,
audio content,
a textual content,
visual or aural entity such as text,
sounds,
documents,
books,
newspaper,
e-services,
personal web pages,
archived e-mail messages,
blogs,
wikis,
discussion forums,
posts,
chats,
tweets,
podcasting,
pins,
and other forms of media that created by users.

8. A method performed by one or more devices, the method comprising:
generating a 9-digit hexadecimal Radio Frequency Device Identification Number allocating a storage subset with generated 9-digit hexadecimal radio frequency device identification number as the unique identifier;
allocating a frequency channel number to the individual user to tune their radio frequency receiver device to listen to their plurality of personalized contents;
configuring a subscriber device with allocated frequency channel number and generated 9-digit radio frequency device identification number;
providing user interaction unit for at least one of the object to make a request to retrieve at least one of the personalized contents;
obtaining a 9-digit hexadecimal Radio Frequency Device Identification Number from received request;
determining at least one of the third party content providers for the received 9-digit hexadecimal Radio Frequency Device Identification Number;
retrieving at least one of the personalized contents from the allocated storage space for the received 9-digit hexadecimal Radio Frequency Device Identification Number;
retrieving at least one of the personalized contents from at least one of the subscribed third party content providers for the received 9-digit hexadecimal Radio Frequency Device Identification Number;
processing at least one of the personalized contents for the received 9-digit hexadecimal Radio Frequency Device Identification Number.

9. The method of claim 8, wherein said object is either a subscriber device that is attached with radio frequency receiver device or a computer readable medium that is stored in user computing device or a telephone device.

10. The method of claim 8, a frequency channel number is chosen between 3 kHz to 300 GHz that is to be configured with subscriber device.

11. The method of claim 8, a 9-digit hexadecimal radio frequency device identification number generated by using date of birth of registered user and allocated subscriber device serial number.

12. The method of claim 8, wherein said processing the retrieved plurality of personalized contents is converting at least one of the personalized contents to the plurality of users preferred language and then converting it to the useful form of input that can be fed into the plurality of users device audio output.

13. The method of claim 8, wherein said personalized content comprises at least one of:
content,
audio content,
a textual content,
visual or aural entity such as text,
sounds,
documents,
books,
newspaper,
e-services,
personal web pages,
archived e-mail messages,
blogs,
wikis,
discussion forums,
posts,
chats,
tweets,
podcasting,
pins,
and other forms of media that created by users.

14. A non-transitory computer readable storage medium containing instructions that, when executed by at least one programmable processor, cause the at least one programmable processor to perform operations comprising:
generating a 9-digit hexadecimal Radio Frequency Device Identification Number allocating a storage subset with generated 9-digit hexadecimal radio frequency device identification number as the unique identifier;
allocating a frequency channel number to the individual user to tune their radio frequency receiver device to listen to their plurality of personalized contents;
configuring a subscriber device with allocated frequency channel number and generated 9-digit radio frequency device identification number;
providing user interaction unit for at least one of the object to make a request to retrieve at least one of the personalized contents;
obtaining a 9-digit hexadecimal Radio Frequency Device Identification Number from received request;
determining at least one of the third party content providers for the received 9-digit hexadecimal Radio Frequency Device Identification Number;
retrieving at least one of the personalized contents from the allocated storage space for the received 9-digit hexadecimal Radio Frequency Device Identification Number;
retrieving at least one of the personalized contents from at least one of the subscribed third party content providers for the received 9-digit hexadecimal Radio Frequency Device Identification Number;
processing at least one of the personalized contents for the received 9-digit hexadecimal Radio Frequency Device Identification Number.

15. The non-transitory computer-readable storage medium of claim 14, wherein said object is either a subscriber device that is attached with radio frequency receiver device or a computer readable medium that is stored in user computing device or a telephone device.

16. The non-transitory computer-readable storage medium of claim 14, a frequency channel number is chosen between 3 kHz to 300 GHz that is to be configured with subscriber device.

17. The non-transitory computer-readable storage medium of claim 14, a 9-digit hexadecimal radio frequency device identification number generated by using date of birth of registered user and allocated subscriber device serial number.

18. The non-transitory computer-readable storage medium of claim 14, wherein said processing the retrieved plurality of personalized contents is converting at least one of the personalized contents to the plurality of users preferred language and then converting it to the useful form of input that can be fed into the plurality of users device audio output.

19. The non-transitory computer-readable storage medium of claim 14, wherein said personalized content comprises at least one of:
content,
audio content,
a textual content,
visual or aural entity such as text,
sounds,
documents,
books,
newspaper,
e-services,
personal web pages,
archived e-mail messages,
blogs,
wikis,
discussion forums,
posts,
chats,
tweets,
podcasting,
pins,
and other forms of media that created by users.
